(19) United States
(12) Patent Application Publication
(10) Pub. No.: US 2015/0120475 A1
(43) Pub. Date: Apr. 30, 2015

(54) EXECUTING AN IN-STORE TRANSACTION

(71) Applicant: Wal-Mart Stores, Inc., Bentonville, AR (US)

(72) Inventors: Douglas James Pedley, Portland, OR (US); Richard Neil Cancro, Portland, OR (US); Joel Bennett Acker, JR., Brush Prairie, WA (US)

(73) Assignee: Wal-Mart Stores, Inc., Bentonville, AR (US)

(21) Appl. No.: 14/062,684

(22) Filed: Oct. 24, 2013

(51) Int. Cl. G06Q 20/20; G06Q 30/06; G06Q 20/32

(52) U.S. Cl. CPC G06Q 20/201; G06Q 20/3276; G06Q 30/0633
USPC 705/20

(57) ABSTRACT

A computer-implemented process is described and includes employing a hand-held communications device to generate a list reflecting contents of a shopping cart. This includes scanning a QR code provided at a point of sale and transmitting the list reflecting contents of the shopping cart to a server. The server communicates the contents of the shopping cart to the point of sale. A bill of sale corresponding to the list reflecting the contents of the shopping cart is generated at the point of sale. A payment is tendered to complete the sale at the point of sale.

### BACKGROUND INFORMATION

1. Field of the Disclosure

The present disclosure relates generally to a retail environment, and In particular, examples of the present invention are related to completion of in-store transactions.

2. Background

Retail marketers offer goods for purchase by shoppers. Individual shoppers in a retail store traverse aisles to peruse and select one or more items for purchase, which they may place in a shopping cart or otherwise convey to a checkout counter where the items are scanned or otherwise accounted for to determine a price. A total price for the selected items is tallied, and the shopper completes the transaction by tendering payment. The checkout counter may be operated by a clerk, or may include a self-scanning system that is overseen by a clerk.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a schematic illustrating a shopping cart and a hand-held communications device, according to some embodiments of the present disclosure;

FIG. 2 is a schematic illustrating a shopping cart at a point-of-sale (POS) including a unique QR code, according to some embodiments of the present disclosure;

FIG. 3 is a schematic illustrating a shopping cart at a POS and a remote server, according to some embodiments of the present disclosure;

FIG. 4 is a schematic illustrating completing a sales transaction at the POS for the shopping cart, according to some embodiments of the present disclosure;

FIG. 5 is a schematic illustrating exemplary components of a hand-held communications device, according to some embodiments of the present disclosure;

FIG. 6 is a schematic illustrating an exemplary remote server enabling processes disclosed herein, according to some embodiments of the present disclosure; and

FIG. 7 illustrates a flowchart of an exemplary process for a customer to scan items into a virtual cart and proceed to a rapid checkout station, according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or process have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure.

Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

By way of introduction, it is appreciated that a portion, and in some cases a significant portion of time that a shopper spends in a retail establishment is expended waiting in line at checkout after the shopper has selected desired items, which may lessen the shopper's buying experience. It is also appreciated that shopping pressure, i.e., quantity of shoppers in a retail establishment, can be unpredictable at times, thus leading to a mismatch between quantity of available checkout clerks and quantity of shoppers desiring to complete their purchases, again lessening a shopper's buying experience or resulting in idle checkout clerks.

A computer-implemented process is described and includes generating a list reflecting contents of a shopping cart onto a hand-held communications device. A QR code provided at a point of sale is scanned and the list reflecting contents of the shopping cart is transmitted from the handheld communications device to a server. The server communicates the contents of the shopping cart to the point of sale. A bill of sale corresponding to the list reflecting the contents of the shopping cart is generated at the point of sale. A payment is tendered to complete the sale at the point of sale. Such a process enables a shopper to scan items to a virtual shopping cart or an electronic sales receipt list and to proceed to a rapid checkout station, wherein the goods scanned can be either summarily paid for or briefly checked for accuracy/content and then paid for.

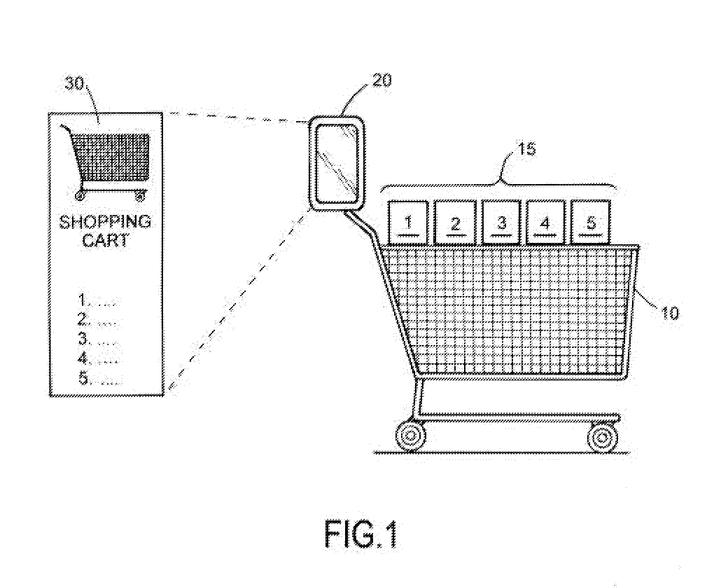

To illustrate, FIG. 1 schematically shows a shopping cart 10 employed by an individual shopper in possession of a hand-held communications device 20 who is engaged in shopping for goods in a retail establishment or another setting. The shopping cart 10 may include or represent any suitable device, including, e.g., a wheeled cart, a handheld basket, a tote bag, or the hands and arms of the individual shopper. The shopping cart 10 contains one or a plurality of goods 15 that the individual shopper intends to purchase. The hand-held communications device 20 is configured to generate a virtual cart 30 that is a content list reflecting the contents of the shopping cart 10. The virtual cart 30 includes an itemized list of the goods 15 and quantities of individual ones of the goods 15 contained in the shopping cart 10. The hand-held communications device 20 generates the virtual cart 30 by any suitable process, including, e.g., scanning a bar code of each of the goods 15 when placed into the shopping cart 10. Preferably the hand-held communications device 20 visually displays and updates the virtual cart 30 when each of the goods 15 is placed into the shopping cart 10. The virtual cart 30 preferably includes a mechanism to include a quantity of one of the goods 15 when multiple units have been selected, such as multiple canned goods or multiple 2″×4″ boards.

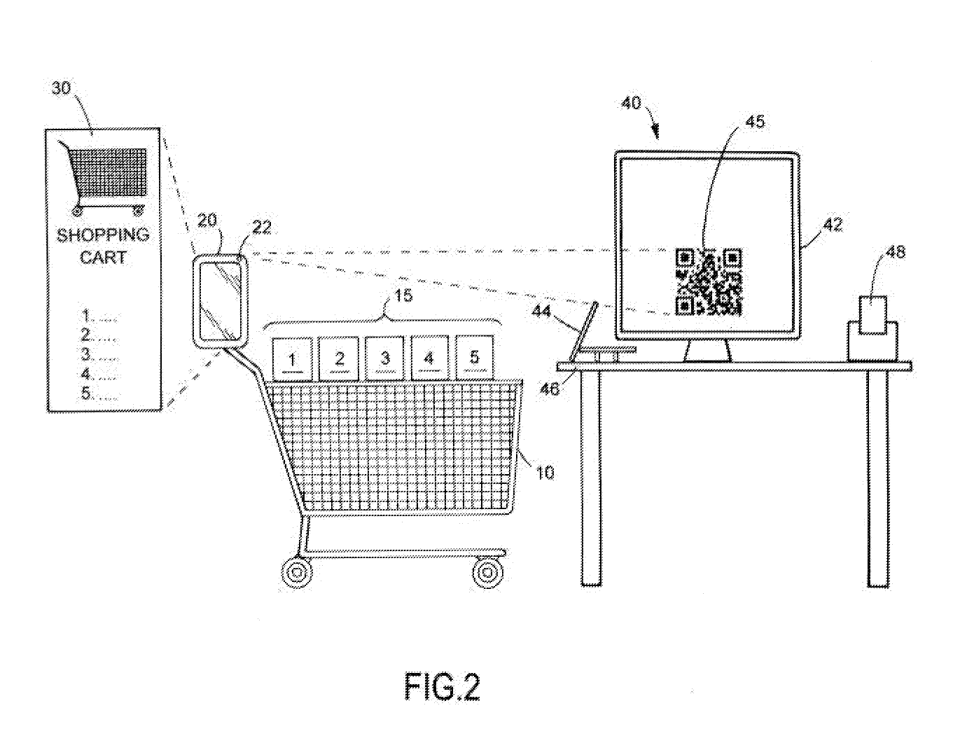

FIG. 2 schematically shows the shopping cart 10 at a point-of-sale (POS) device 40, preferably located near an entrance and/or exit of the retail establishment. The POS 40 preferably includes a display screen 42, a register 44, a counter surface 46, and a printer 48. The POS 40 can be a physical location at which a transaction occurs in exchange for the goods 15. Each transaction preferably includes tallying values of the goods 15 in the shopping cart 10, making a monetary payment, and generating a receipt. The POS 40 includes a unique QR code 45 that identifies its location. When an individual shopper arrives at the POS 40, they employ a scanner 22 on the hand-held communications device 20 to scan the QR code 45. The QR code 45 includes a pairing code that facilitates communication from the hand-held communications device 20.

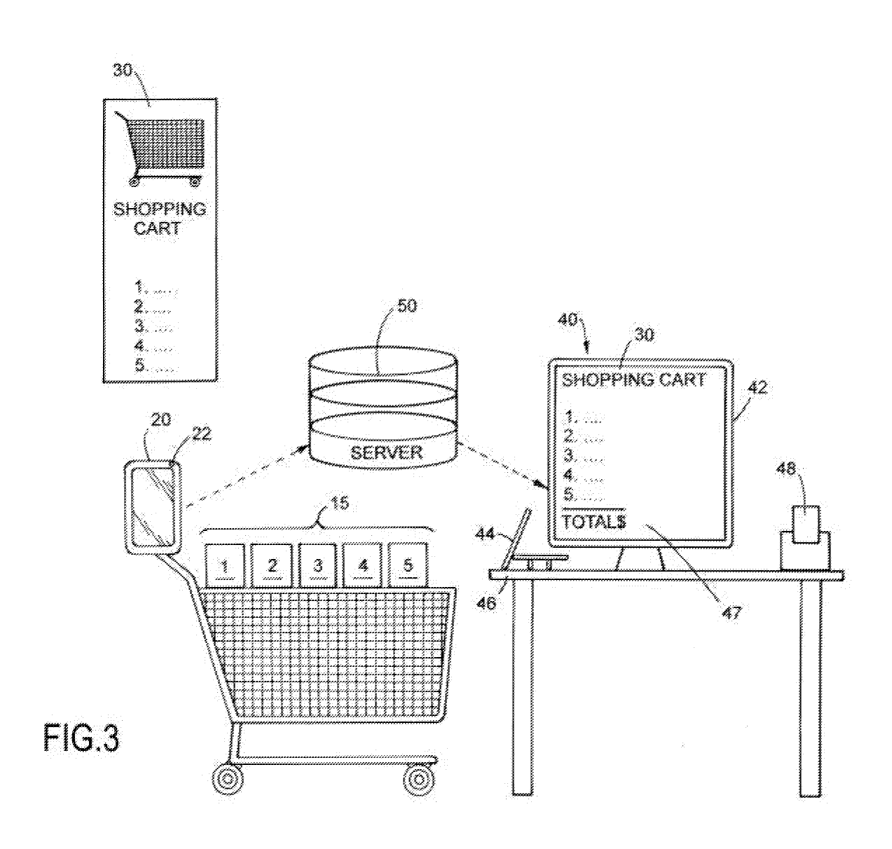

FIG. 3 schematically shows the shopping cart 10 at the POS 40 and a remote server 50. The remote server 50 is a computing device having communications capability that can be located remotely or at the retail establishment. The remote server 50 preferably includes other retail functions, including, e.g., inventory management. When the hand-held communications device 20 scans the QR code 45, the pairing code contained in the QR code 45 facilitates communication of the virtual cart 30 from the hand-held communications device 20 to the remote server 50. The remote server 50 assigns prices to the individual goods 15 contained in the virtual cart 30, tallies a total cost 47 including applicable sales taxes, etc., and communicates the virtual cart 30 including the total cost 47 to the POS 40. The POS 40 visually displays the virtual cart 30 and total cost 47 on the display screen 42 for review by the individual shopper. A sales clerk may be tasked with verifying that the contents of the virtual cart 30 match the plurality of goods 15 contained in the shopping cart 10.

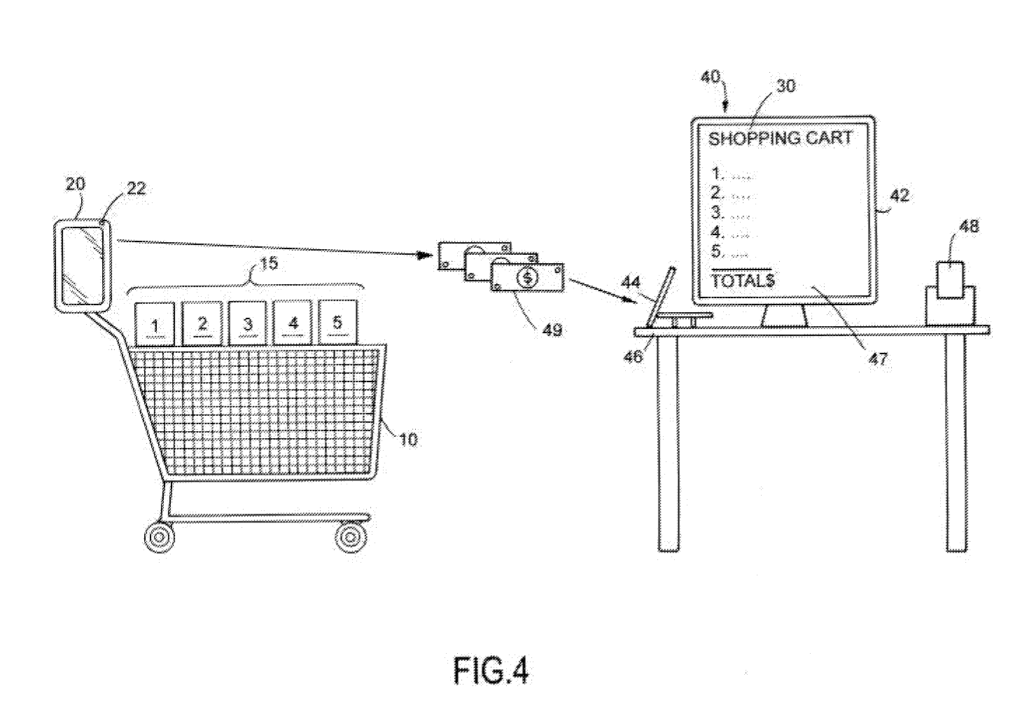

FIG. 4 schematically shows completing a sales transaction at the shopping cart 10 at the POS 40. When the individual shopper agrees to the total cost 47 for the contents of the shopping cart 10, they tender a payment 49 in a form that is captured and recorded at the register 44. Payment 49 can include any form of monetary exchange, including, e.g., an exchange of cash, check, check card, or credit card, or other suitable payment. Cash can be received by a store employee, or cash can be received automatically through a bill accepting device known in the art. Alternatively, the transaction can be linked through the hand-held communication device to a third-party payment service, such as PayPal™. The printer 48 prints a physical copy of a sales receipt. Alternatively or in addition, an electronic copy of a sales receipt can be communicated to the hand-held communications device 20.

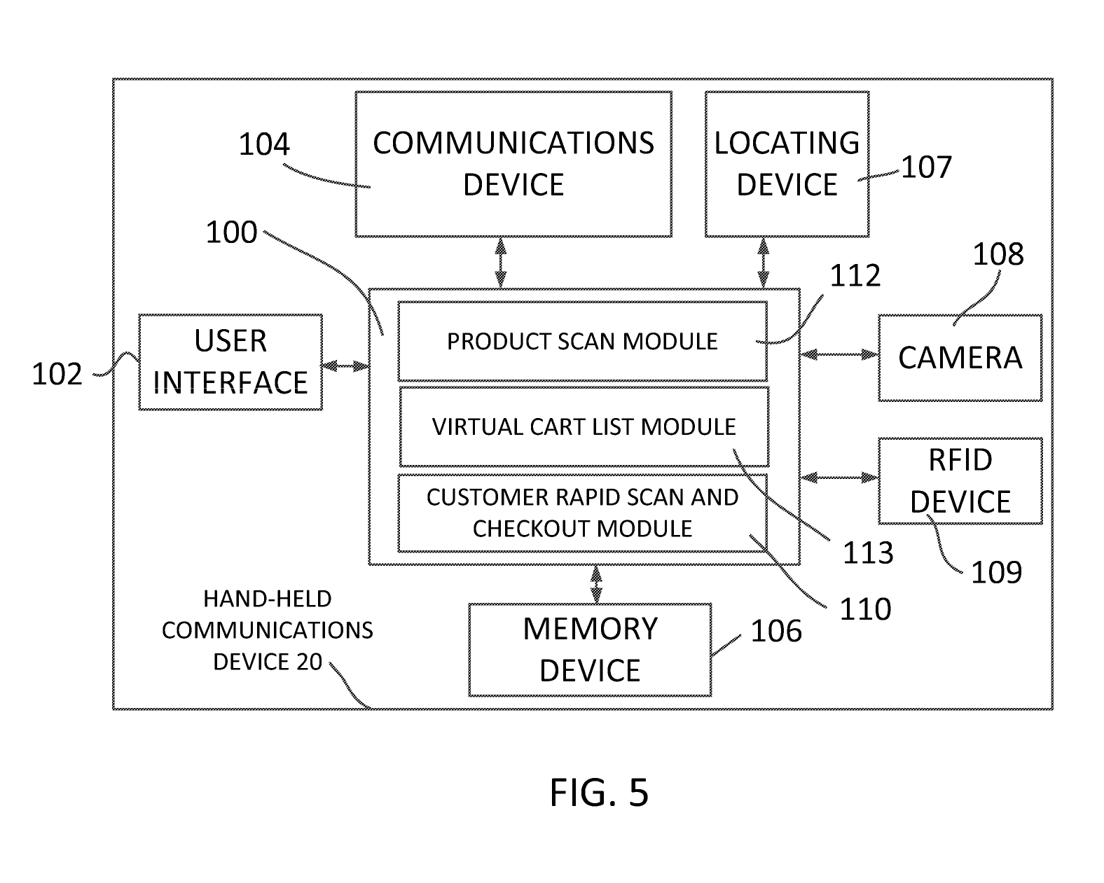

Referring now to FIG. 5, a schematic illustrating exemplary components of a portable computerized device embodied as the hand-held communications device of FIG. 1 is illustrated. In the illustrative embodiment, the hand-held communications device 20 includes a processing device 100, a user interface 102, communication device 104, a memory device 106, a locating device 107, a camera device 108, and a Radio Frequency Identification Device (RFID) 109. It is noted that the hand-held communications device 20 can include other components and some of the components are not always required. Hand-held communications device 20 can be operated as a customer operated purchasing device for use in a process to permit a customer to scan items to an electronic sales receipt list and proceed to a rapid checkout, as disclosed herein.

The processing device 100 can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. The processing device 100 can execute the operating system of the hand-held communications device 20. In the illustrative embodiment, the processing device 100 also executes a customer rapid scan and checkout module 110 and a product scan module 112, and a virtual cart list module 113, which are described in greater detail below.

User interface 102 is a device that allows a user to interact with the hand-held communications device 20. While one user interface 102 is shown, the term “user interface” can include, but is not limited to, a touch screen, a physical keyboard, a mouse, a microphone, and/or a speaker.

The communication device 104 is a device that allows the hand-held communications device 20 to communicate with another device, e.g., the remote server 50, via a wireless or communications network. The communication device 104 can include one or more wireless transceivers for performing wireless communication and/or one or more communication ports for performing wired communication.

The memory device 106 is a device that stores data generated or received by the hand-held communications device 20. Memory device 106 can include, but is not limited to, a hard disc drive, an optical disc drive, and/or a flash memory drive.

The locating device 107 determines a location of the hand-held communications device 20 according to processes known in the art. According to one embodiment, locating device can include an RTLS device, for example, utilizing cell phone tower signals to triangulate or otherwise determine a location of the device.

The camera 108 is a digital camera that captures a digital photograph. Camera 108 receives an instruction to capture an image, captures an image of an object, i.e., a barcode of a product, and outputs the digital photograph. The digital photograph can be a bitmap, a JPEG, a GIF, or any other suitably formatted file. The camera 108 can receive the instruction to capture the image from the processing device 100 and can output the digital photograph to the processing device 100. As disclosed herein, an object can be scanned by the hand-hand communications device in order to add the item to a virtual cart. Such scanning can include taking a photo of a barcode located on the product. In another embodiment, scanning can include simply holding the product in front of the camera device and while the camera device captures a series of images. Image recognition programming can be used to identify a product or barcode of a product from an image or series of images, with the barcode proximity to the camera device being used as an indication that the customer intends to purchase the item and add it to the virtual cart.

The Radio Frequency Identification Device (RFID) 109 can determine the location of the hand-held communications device 20 by triangulating positions by using Radio Frequency Identification Device (RFID) radio signals from small transmitters placed throughout a building in known locations. In another embodiment, RFID device 109 can determine proximity of the device to a mobile feature, such as a store clerk, or proximity to a temporary or one-time display not loaded into a store database.

The customer rapid scan and checkout module 110 includes programming enabling a user to walk through the store, scan items for purchase, put the items into the user's shopping cart or bag, and proceed through a rapid checkout process, wherein an virtual cart list including the products scanned and put into the cart or bag are used to provide for easy payment for the products purchased. Items scanned are tallied, and according to processes disclosed herein, the store provides the customer with an ability to pay for the goods and exit the store. According to the embodiment of FIG. 2, module 110 includes programming to identify QR code 45 and communicate with a remote server to process information related to completing a purchase of items from the virtual cart at the checkout associated with QR code 45.

Product scan module 112 monitors data from a camera device and identifies a information related to a scanned product, so that the product can be purchased. Product scan module 112 can include image recognition software to identify object information such as a barcode or logo information, or product scan module 112 processes such images so that they can be processed in a remote server to identify the object information.

Virtual cart list module 113 monitors operation of the product scan module 112 and maintains a list of items in the virtual cart. Module 113 can include programming to tally the goods being purchased and provide information to remote server 50 required to complete the purchase.

Embodiments in accordance with the present invention may be embodied as an apparatus, process, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied an any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.)

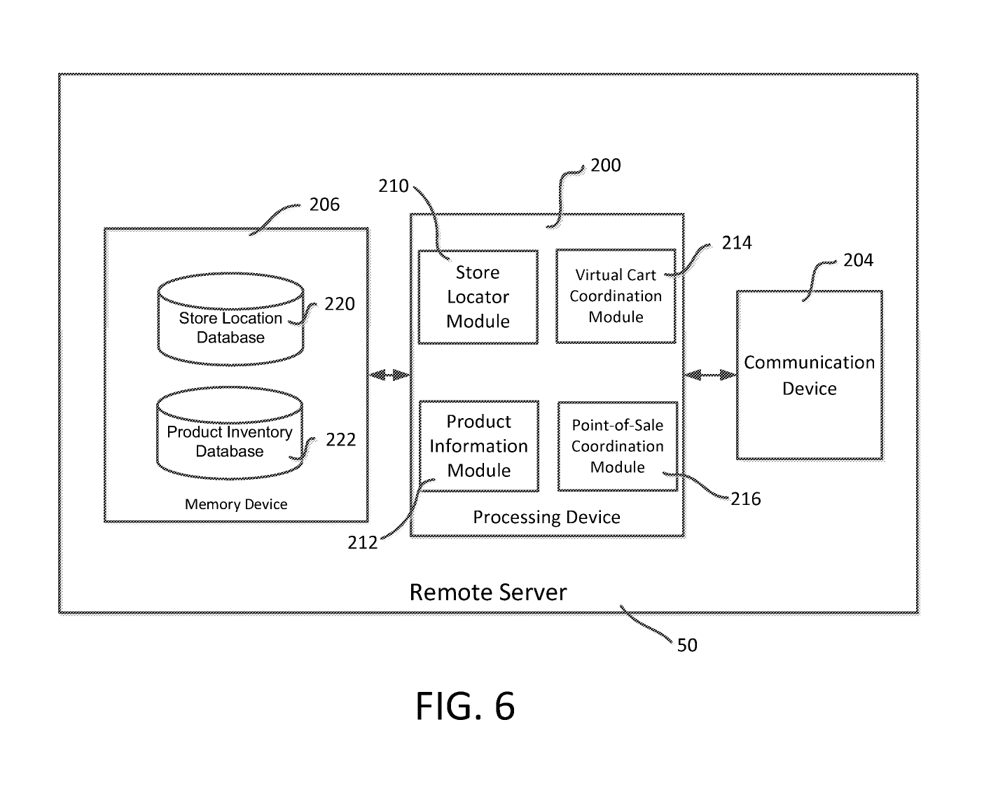

FIG. 6 is a schematic illustrating an exemplary remote server enabling processes disclosed herein. In the illustrated embodiment, the remote server 50 may include a processing device 200, a communication device 204, and memory device 206.

The processing device 200 can include memory, e.g., read only memory (ROM) and random access memory (RAM), storing processor-executable instructions and one or more processors that execute the processor-executable instructions. In embodiments wherein the processing device 200 includes two or more processors, the processors can operate in a parallel or distributed manner. In the illustrative embodiment, the processing device 200 executes one or more of a store locator module 210, a product information module 212, a virtual cart coordination module 214, and a point-of-sale coordination module 216.

The communication device 204 is a device that allows the remote server 50 to communicate with another device, e.g., the hand-held communication device, via a network. The communication device 204 can include one or more wireless transceivers for performing wireless communication and/or one or more communication ports for performing wired communication.

The memory device 206 is a device that stores data generated or received by the remote server 50. The memory device 206 can include, but is not limited to a hard disc drive, an optical disc drive, and/or a flash memory drive. Further, the memory device 206 may be distributed and located at multiple locations. The memory device 206 is accessible to the processing device 200. In some embodiments, the memory device 206 includes a store location database 220 and a product information database 222.

In some embodiments, the store location database 220 can store the store locations of one or more stores operated or associated with a retailer. The store location database 220 may be queried using a specific location, e.g., GPS coordinates, or a general location, e.g., postal zip code or city/state, and can return one or more stores that are proximate to the specific or general location. The store location database 220 may further be configured to store maps corresponding to each store location. The store location database 220 may be queried with a store location and can return the store map corresponding to the store location.

As discussed, the processing device 200 may execute the store locator module 210. The store locator module 210 receives a location from the portable computerized device and determines one or more store locations corresponding to the received location. In some embodiments, the store locator module 210 queries the store location database 220 with the received location and receives one or more store locations that correspond to the received location. For example, the store location database 220 may return any store locations that are within a predetermined distance, e.g., 10 miles, from the received location. When more than one store location is received, the store locator module 210 may automatically select the store location nearest to the received location or may provide the store locations to the portable computerized device, thereby allowing the portable computerized device or the user to select the store location.

The product information database 222 stores information about products in inventory of one or more stores. Database 222 interacts with product information module 212 such that queries regarding products including prices, barcode labels, logos present on packaging, and other information regarding different products can be accessed. Product information database 222 can store and provide information specific to particular store locations as returned by store locator module 210.

The product information module 212 receives an object receives information from a customer scan of a barcode or other similar information and can query database 222 to determine details of a product is associated with the customer scan. Such information can include a price.

Virtual cart coordination module 214 can perform operations as disclosed in relation to virtual cart list module 113, such that programming to build and maintain a list of object in a virtual cart can be operated at either the hand-held communication device or at the server. In addition or in the alternative, virtual cart coordination module 214 can share information with virtual cart list module 113 and include programming to coordinate retrieval of information through product information module 212 and processing of a list of products in the virtual cart to the point-of-sale coordination module.

Point-of-sale coordination module 216 includes programming to process the list of goods in the virtual cart for communication to the POS 40. According to one embodiment, point-of-sale coordination module 216 can include programming to identify a particular rapid checkout station based upon the customer scanning a QR code upon a screen of the POS, as disclosed herein. Identification of the particular checkout station can also include information from store locator module 210.

Portable computerized devices embodied as a hand-held communications device as disclosed herein can take a number of different embodiments. Such a device can include a smart phone, a tablet computer, a laptop computer, or glasses equipped to project images in a view of the user. Such a hand-held communications device can be owned by the store and permanently affixed to the shopping cart. Exemplary portable computerized devices are provided, but the disclosure is not intended to be limited to the provided examples.

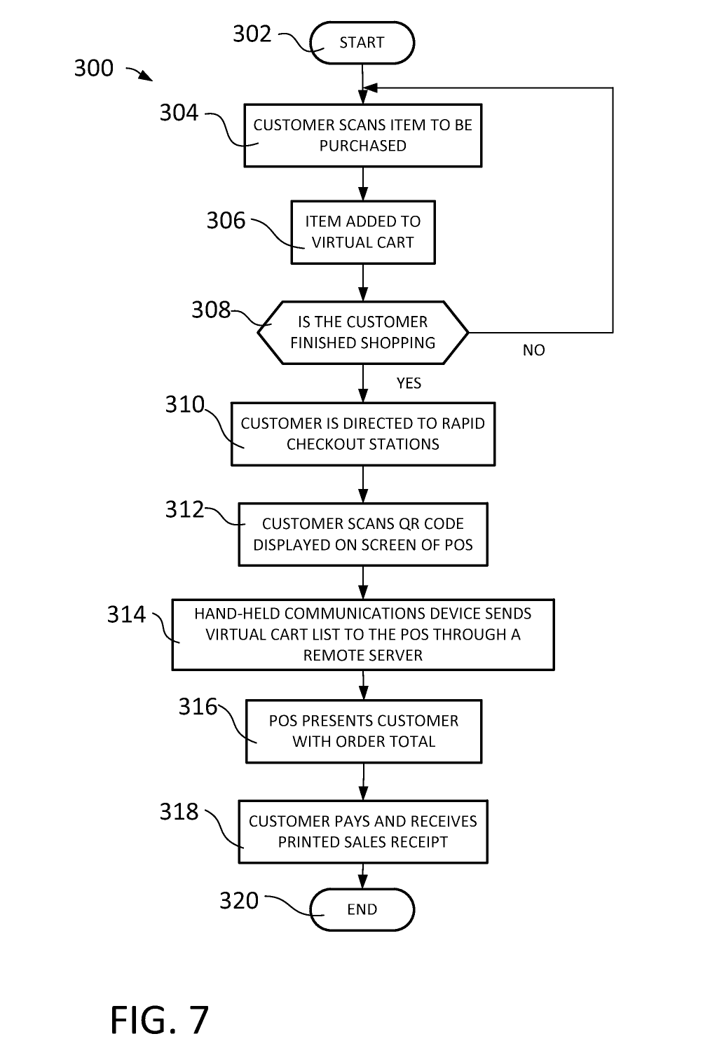

FIG. 7 illustrates a flowchart of an exemplary process for a customer to scan items into a virtual cart and proceed to a rapid checkout station. Process 300 begins at step 302. At step 304, the customer scans an item to be purchased. At step 306, the item is added to a virtual cart list. At step 308, a determination is made whether the customer is finished shopping. If the customer is not finished shopping, the process returns to step 304. If the customer is finished shopping the process advances to step 310, whereat the customer is directed to a plurality of rapid checkout stations. At step 312, the customer scans with his or her hand-held communications device a QR code displayed upon a screen of a POS of one of the rapid checkout stations. Through this scan, the particular rapid checkout station selected to process the virtual cart list of the customer is identified. At step 314, the hand-held communications device sends the virtual cart list to the POS through a remote server. At step 316, the POS presents the customer with an order total. At step 318, the customer pays and receives a printed sales receipt. At step 320, the process ends. A number of exemplary processes to operate a virtual cart and a rapid checkout are envisioned, and the disclosure is not intended to be limited to the particular examples provided herein.

The flowchart and block diagrams in the flow diagrams illustrate the architecture, functionality, and operation of possible implementations of systems, processes, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Processes disclosed herein include providing a printed receipt or bill of sale to the customer. Additionally or alternatively, a bill of sale can be presented to the customer electronically through the hand-held communications device or a registered email account.

The above description of illustrated examples of the present disclosure, including what is described in the Abstract, are not intended to be exhaustive or to be limitation to the precise forms disclosed. While specific embodiments of, and examples for, the disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A computer-implemented process permitting a customer in a retail store to scan items to be purchased and proceed to a rapid checkout station, the process comprising:
within a processor of a hand-held communications device:
generating a list reflecting contents of a shopping cart;
scanning a QR code provided at a point of sale;
transmitting the list reflecting contents of the shopping cart to a server, the server communicating the contents of the shopping cart to the point of sale;
at the point of sale, generating a bill of sale corresponding to the list reflecting the contents of the shopping cart; and
in a computerized processing device, executing a monetary transaction to complete the sale at the point of sale.

2. The process of claim 1, further comprising communicating the bill of sale to a hand-held communications device.

3. The process of claim 1, further comprising communicating the bill of sale to a registered email account.

4. The process of claim 1, wherein the point of sale comprises a checkout counter in a retail establishment.

5. The process of claim 1, wherein the scanning the QR code comprises scanning a QR code at one of a plurality of rapid checkout stations.

6. The process of claim 1, wherein executing the monetary transaction comprises:
displaying upon a graphical display an order total; and
receiving payment from the customer for the order total.

7. The process of claim 6, wherein receiving payment from the customer comprises linking to a third party payment service through the hand-held communication device.

8. The process of claim 1, wherein generating the list comprises scanning with the hand-held communications device an item to be purchased and communicating with the server to retrieve a price for the item.

9. A computerized server comprising:
within the server:
a virtual cart coordination module receiving from a hand-held communications device a virtual cart list of a customer shopping in a retail store, the list including items the customer has scanned and placed in a shopping cart;
a point-of-sale coordination module:
monitoring a QR code scan corresponding to a quick checkout station that the customer intends to utilize; and
transferring information about the virtual cart list to the quick checkout station.

10. The computerized server of claim 9, further comprising, within the server, a product information module providing a price for each of the items on the list.

11. The computerized server of claim 9, wherein the server transmits an electronic bill of sale from the quick check station to the hand-held communications device.

12. The computerized server of claim 9, further comprising, within the server, a store locator module to determine which store location the customer is within.

13. A software application including programming to permit a customer to scan at least one item for purchase to a virtual cart and to proceed to a rapid checkout station, the software application operating upon a hand-held communications device, the application comprising:
within a processor of the hand-held communications device:
receiving an image captured by a camera device of the hand-held communications device, the image including a barcode from the item for purchase;
transmitting information from the image to a remote server;
receiving an identification of the item;
adding the item to the virtual cart;
receiving an image captured by the camera device of a QR code associated with a rapid checkout station; and
transmitting the virtual cart for display upon the rapid checkout station.

14. The software application of claim 13, further comprising, within the processor, receiving an electronic bill of sale from the rapid checkout station.

15. The software application of claim 13, further comprising providing payment through a link with a third party payment service.
